(19) United States
(12) Patent Application Publication
(10) Pub. No.: US 2026/0247234 A1
(43) Pub. Date: Aug. 20, 2026

(54) METHODS AND APPARATUS FOR MANAGING LTM IN A WIRELESS COMMUNICATION SYSTEM USING NR-DC

(71) Applicant: Samsung Electronics Co., Ltd., Gyeonggi-do (KR)

(72) Inventor: Aby Kanneath ABRAHAM, Bangalore (IN)

(21) Appl. No.: 19/161,993

(22) PCT Filed: Mar. 20, 2024
(86) PCT No.: PCT/KR2024/003490

§ 371 Date: Sep. 3, 2025

(30) Foreign Application Priority Data
Mar. 21, 2023 (IN) 202341019618
Mar. 8, 2024 (IN) 202341019618

(51) Int. Cl. H04W 36/04; H04W 36/00; H04W 76/20

(52) U.S. Cl. CPC H04W 36/04; H04W 36/0069; H04W 76/20

(57) ABSTRACT

The disclosure relates to a 5G or 6G communication system for supporting a higher data transmission rate. Methods and systems for managing LTM in NR-DC, Embodiments disclosed herein relate to methods (400, 500, 600, 700, 800) and systems (100) for managing a Lower-layer Triggered Mobility (LTM) in New Radio-Dual Connectivity (NR-DC). The proposed methods (400, 500, 600, 700, 800) include handling of one or more LTM configurations in New Radio (NR), when dual connectivity is configured. The methods (400, 500, 600, 700, 800) include configuring the LTM where the UE (102) may receive the LTM configuration from both a Master Node (MN) (112) and a Secondary Node (SN) (114) including the methods (400, 500, 600, 700, 800) for handling the configurations received from the MN 112 and the SN 114, and apply the received configuration independently. The methods (400, 500, 600, 700, 800) include configuring the LTM for both the MN (112) and the SN (114), including the simultaneous configuration.

### TECHNICAL FIELD

Embodiments disclosed herein relate to wireless communication networks, and more particularly to methods and systems for managing a Lower-layer Triggered Mobility (or Layer 1/Layer 2 (L1/L2) Triggered Mobility) (LTM) in New Radio-Dual Connectivity (NR-DC) and handling configurations for the LTM.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user con-venience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The principal object of the embodiments herein is to disclose methods and systems for managing Lower-layer Triggered Mobility (or Layer 1/Layer 2 (L1/L2) Triggered Mobility) (LTM) in New Radio (NR).

Another object of embodiments herein is to disclose methods and systems for handling Lower-layer Triggered Mobility (LTM) in dual connectivity.

Another object of embodiments herein is to disclose methods and systems for handling one or more User Equipment (UE) variables for a Lower-layer Triggered Mobility (LTM) in New Radio (NR), when dual connectivity is configured.

Another object of embodiments herein is to disclose methods and systems for configuring the LTM where a UE may receive the LTM configuration from both a Master Node (MN) and a Secondary Node (SN) including the methods for handling the configurations received from MN and SN, and apply the received configuration independently.

Another object of embodiments herein is to disclose methods and systems for configuring LTM for both the MN and the SN, including the simultaneous configuration.

### Solution to Problem

Accordingly, the embodiments herein provide a method for managing a Lower-layer Triggered Mobility (LTM) in New Radio-Dual Connectivity (NR-DC). The method comprises receiving, by a User Equipment (UE), at least one LTM configuration from a network. The LTM configuration is received from at least one of a Master Node (MN) via a Signaling Radio Bearer 1 (SRB1), and a Secondary Node (SN) via a SRB3. The method comprises associating, by the UE, the LTM configuration to at least one cell group based on receiving the LTM configuration from at least one of the MN and the SN. The method comprises maintaining, by the UE, the LTM configuration for each associated cell group independently. Thereafter, the method includes configuring, by the UE, the LTM configuration for the associated cell group for performing at least one LTM operation for each associated cell group independently.

Accordingly, the embodiments herein provide a UE. The UE comprises a processor and a memory module. The processor is coupled with the memory module. The processor is configured to receive at least one LTM configuration from a network. The LTM configuration is received from at least one of the MN via SRB1, and the SN via SRB3. The processor is configured to associate the LTM configuration to at least one cell group, based on receiving the LTM configuration from at least one of the MN and the SN. The processor is configured to maintain the LTM configuration for each associated cell group independently. The processor is configured to configure the LTM configuration for the associated cell group for performing at least one LTM operation for each associated cell group independently.

Accordingly, the embodiments herein provide a method for managing LTM in NR-DC by the MN. The method comprises generating, by the MN, at least one MCG LTM configuration associated with a Master Cell Group (MCG). The method comprises receiving, by the MN, at least one SCG LTM configuration associated with a Secondary Cell Group (SCG), from the SN in a SN Radio Resource Control (RRC) reconfiguration message. The method comprises embedding, by the MN, the received SN RRC reconfiguration message containing the SCG LTM configuration in a MN RRC reconfiguration message. Thereafter, the method comprises sending, by the MN, at least one of the generated MCG LTM configuration associated with the MCG, and the embedded SN RRC reconfiguration message containing the SCG LTM configuration associated with the SCG, to the UE, in the MN RRC reconfiguration message via SRB1. The UE thereby performs at least one LTM operation for at least one of the MCG and the SCG independently using the MCG LTM configuration, and the SCG LTM configuration.

Accordingly, the embodiments herein provide a MN which comprises a processor and a memory module. The processor is coupled with the memory module. The processor is configured to generate at least one MCG LTM configuration associated with the MCG. The processor is configured to receive at least one SCG LTM configuration associated with the SCG, from the SN in a SN RRC reconfiguration message. The processor is configured to embed the received SN RRC reconfiguration message containing the SCG LTM configuration in a MN RRC reconfiguration message. Further, the processor is configured to send at least one of the generated MCG LTM configuration associated with the MCG, and the embedded SN RRC reconfiguration message containing the SCG LTM configuration associated with the SCG, to the UE, in the MN RRC reconfiguration message via SRB1, for enabling the UE to perform at least one LTM operation for at least one of the MCG and the SCG independently using the MCG LTM configuration, and the SCG LTM configuration.

Accordingly, the embodiments herein provide a method for managing LTM in NR-DC by the SN. The method comprises generating, by the SN, at least one SCG LTM configuration associated with the SCG. Thereafter, the method comprises sending, by the SN, the generated SCG LTM configuration associated with the SCG to at least one of the UE, and the MN, for enabling the UE to perform at least one LTM operation for the SCG using the SCG LTM configuration.

Accordingly, the embodiments herein provide a SN which comprises a processor and a memory module. The processor is coupled with the memory module. The processor is configured to generate at least one SCG LTM configuration associated with the SCG. Further, the processor is configured to send the generated SCG LTM configuration associated with the SCG to at least one of the UE and the MN, for enabling the UE to perform at least one LTM operation for the SCG using the SCG LTM configuration.

Accordingly, the embodiments herein provide a method performed by a user equipment (UE) in a communication system, the method comprising: obtaining a radio resource control (RRC) message including at least one layer1/layer2 triggered mobility (LTM) configuration associated with at least one of a master cell group (MCG) or a secondary cell group (SCG); in case that two independent LTM configuration including an LTM configuration associated with the MCG and an LTM configuration associated with the SCG is received independently, maintaining two independent UE variable, each of the two independent UE variable being associated with each of the two independent LTM configuration; and performing an LTM configuration procedure for the two independent LTM configuration independently.

Accordingly, the embodiments herein provide a method performed by a base station in a communication system, the method comprising: obtaining a radio resource control (RRC) message including at least one layer1/layer2 triggered mobility (LTM) configuration associated with at least one of a master cell group (MCG) or a secondary cell group (SCG); and transmitting, to a user equipment (UE), the obtained RRC message; wherein in case that two independent LTM configuration including an LTM configuration associated with the MCG and an LTM configuration associated with the SCG is received independently, two independent UE variable is maintained, each of the two independent UE variable being associated with each of the two independent LTM configuration; and wherein an LTM configuration procedure for the two independent LTM configuration is performed independently.

Accordingly, the embodiments herein provide a user equipment (UE) in a communication system, the UE comprising: a transceiver; and a controller coupled with the transceiver configured to: obtain a radio resource control (RRC) message including at least one layer1/layer2 triggered mobility (LTM) configuration associated with at least one of a master cell group (MCG) or a secondary cell group (SCG), in case that two independent LTM configuration including an LTM configuration associated with the MCG and an LTM configuration associated with the SCG is received independently, maintain two independent UE variable, each of the two independent UE variable being associated with each of the two independent LTM configuration, and perform an LTM configuration procedure for the two independent LTM configuration independently.

Accordingly, the embodiments herein provide a base station in a communication system, the base station comprising: a transceiver; and a controller coupled with the transceiver configured to: obtain a radio resource control (RRC) message including at least one layer1/layer2 triggered mobility (LTM) configuration associated with at least one of a master cell group (MCG) or a secondary cell group (SCG); and transmit, to a user equipment (UE), the obtained RRC message; wherein in case that two independent LTM configuration including an LTM configuration associated with the MCG and an LTM configuration associated with the SCG is received independently, two independent UE variable is maintained, each of the two independent UE variable being associated with each of the two independent LTM configuration; and wherein an LTM configuration procedure for the two independent LTM configuration is performed independently.

These and other aspects of the example embodiments herein will be better ap-preciated and understood when considered in conjunction with the following description and the accompanying drawings. It should be understood, however, that the following descriptions, while indicating example embodiments and numerous specific details thereof, are given by way of illustration and not of limitation. Many changes and modifications may be made within the scope of the example embodiments herein without departing from the spirit thereof, and the example embodiments herein include all such modifications.

### Advantageous Effects of Invention

According to an embodiment of the disclosure, a wireless communication can be performed efficiently. Especially, a LTM can be managed efficiently.

### BRIEF DESCRIPTION OF DRAWINGS

Embodiments herein are illustrated in the accompanying drawings, throughout which like reference letters indicate corresponding parts in the various figures. The embodiments herein will be better understood from the following description with reference to the following illustratory drawings. Embodiments herein are illustrated by way of examples in the accompanying drawings, and in which:

FIG. 1 illustrates a system for managing a Lower-layer Triggered Mobility (LTM) in NR-DC, according to embodiments as disclosed herein;

FIG. 2 illustrates a block representation of the MN, according to embodiments as disclosed herein;

FIG. 3 illustrates a block representation of the SN, according to embodiments as disclosed herein;

FIG. 4 illustrates a method for managing LTM in NR-DC, according to embodiments as disclosed herein;

FIG. 5 is a flow chart illustrating a method for creating different UE variables for SCG and MCG in LTM, according to embodiments as disclosed herein;

FIG. 6 is a method for managing LTM by the MN, according to embodiments as disclosed herein;

FIG. 7 is a method for managing LTM by the SN, according to embodiments as disclosed herein; and

FIG. 8 is a flow chart illustrating a method for updating a LTM configuration for LTM, according to embodiments as disclosed herein.

### MODE FOR THE INVENTION

Mobility in New Radio (NR): In wireless technologies such as 5G NR, devices can move across different cells. Mobility is performed using a procedure called cell res-election in a Radio Resource Control (RRC)_IDLE mode. Till NR R17, mobility is performed using a procedure called handover in the RRC_CONNECTED mode. Network controlled mobility applies to User Equipments (UEs) in the RRC_CONNECTED mode. This requires explicit RRC signalling to be triggered by a Next Generation Node B (gNB) in NR. Handover in NR usually consists of three steps: handover preparation, handover execution and handover completion. gNB can configure the UE to report measurements and based on the reported measurements or based on its own understanding of the network topology, the gNB can send a RRC reconfiguration message to handover the UE to another cell called target cell from a source cell. Later, the UE can access the target cell and send an RRC reconfiguration complete message. In an alternative way introduced in 3GPP NR release 16, the gNB can configure the UE with the execution conditions for triggering handover and once the execution conditions are satisfied, the UE can move to the target cell and send the RRC reconfiguration complete. In all the above methods, the UE performs handover by sending Layer 3 (L3) RRC messages which can cause considerable signalling overhead and latency issues. During handover, the UE can be configured to apply full configuration during a L3 handover, and if configured UE applies full configuration as described in section 5.3.5.11 of TS 38.331.

3GPP release 18 considers Lower layers (L1/L2 layers) Triggered Mobility, also known as LTM. As per 3GPP, the goal of LTM is to enable a serving cell change via Layer 1 (L1)/Layer 2 (L2) signalling, in order to reduce the latency, overhead, and in-terruption time. Network (gNB) may configure the UE with multiple candidate cells to allow fast application of configuration for candidate cells. Network may further send MAC CE or L1 signalling to dynamically switch the UE from a source cell to one of the configured candidate cells. Further, LTM can be triggered based on L1 measurements rather than L3 measurements.

3GPP proposes to perform LTM, without reset of lower layers like MAC to avoid data loss and to reduce additional delay of data recovery wherever possible. gNB may provide LTMCandidateConfiguration, for example to configure LTM candidate cells through one RRCReconfiguration message for a candidate target cell or through one CellGroupConfig for each candidate target cell or through any similar RRC structure or IE containing the similar fields (for example, a new IE LTM-CandidateConfig can be defined as ASN.1 sequence containing cellgroupconfig and some other information elements in the RRCReconfiguration). gNB may further release or modify the candidate configurations. The UE may store an LTM configuration of other candidate cells even after moving to a candidate cell through LTM.

To avoid transmitting a large message over air interface, gNB can provide a LTMCandidateConfiguration as delta configuration instead of full configuration. gNB can indicate the UE to use a source cell configuration as a reference for delta configuration or provide a reference configuration explicitly.

gNB may provide LTMCandidateConfiguration, i.e., configure one or more LTM candidate cells through one RRCReconfiguration message for a candidate target cell or through one CellGroupConfig for each candidate target cell or through any similar RRC structure or IE containing the similar fields (for example, a new IE LTM-CandidateConfig can be defined as ASN.1 sequence containing CellGroupConfig and some other information elements in the RRCReconfiguration). gNB may further release or modify the candidate configurations. The UE may store the LTM configuration of other candidate cells even after moving to a candidate cell through LTM. gNB may also provide the UE with configuration for performing LTM measurements for different candidate frequencies and candidate cells, and reporting based on the performed LTM measurements.

gNB can provide a reference configuration, an L1 measurement configuration and a candidate cell configuration in a RRC ASN.1 SEQUENCE used for the LTM Configuration.

An example sequence is given as below:

```
    ASN1START
    -- TAG-RRCRECONFIGURATION-START
```

| | |
|---|---|
| RRCReconfiguration ::= | SEQUENCE { |
| rrc-TransactionIdentifier | RRC- |

TransactionIdentifier,

| | |
|---|---|
| criticalExtensions | CHOICE { |
| rrcReconfiguration | RRCReconfiguration- |

Ies,

| | |
|---|---|
| criticalExtensionsFuture | SEQUENCE { } |

```
        }
    }
```

| | |
|---|---|
| RRCReconfiguration-Ies ::= | SEQUENCE { |
| radioBearerConfig | RadioBearerConfig |

OPTIONAL, -- Need M

| | |
|---|---|
| secondaryCellGroup | OCTET STRING (CONTAINING |
| CellGroupConfig) | OPTIONAL, -- Cond SCG |
| measConfig | MeasConfig |

OPTIONAL, -- Need M

| | |
|---|---|
| lateNonCriticalExtension | OCTET STRING |

OPTIONAL,

| | |
|---|---|
| nonCriticalExtension | RRCReconfiguration- |
| v1530-Ies | OPTIONAL |

}

| | |
|---|---|
| RRCReconfiguration-v1530-Ies ::= | SEQUENCE { |
| masterCellGroup | OCTET STRING (CONTAINING |
| CellGroupConfig) | OPTIONAL, -- Need M |
| fullConfig | ENUMERATED {true} |

OPTIONAL, -- Cond FullConfig

| | |
|---|---|
| dedicatedNAS-MessageList | SEQUENCE |
| (SIZE(1..maxDRB)) OF DedicatedNAS-Message | OPTIONAL, -- |

Cond nonHO

| | |
|---|---|
| masterKeyUpdate | MasterKeyUpdate |

OPTIONAL, -- Cond MasterKeyChange

| | |
|---|---|
| dedicatedSIB1-Delivery | OCTET STRING (CONTAINING |
| SIB1) | OPTIONAL, -- Need N |
| dedicatedSystemInformationDelivery | OCTET STRING (CONTAINING |
| SystemInformation) | OPTIONAL, -- Need N |
| otherConfig | OtherConfig |

OPTIONAL, -- Need M

| | |
|---|---|
| nonCriticalExtension | RRCReconfiguration- |
| v1540-Ies | OPTIONAL |

}

| | |
|---|---|
| RRCReconfiguration-v1540-Ies ::= | SEQUENCE { |
| otherConfig-v1540 | OtherConfig-v1540 |

OPTIONAL, -- Need M

| | |
|---|---|
| nonCriticalExtension | RRCReconfiguration- |
| v1560-Ies | OPTIONAL |

}

| | |
|---|---|
| RRCReconfiguration-v1560-Ies ::= | SEQUENCE { |
| mrdc-SecondaryCellGroupConfig | SetupRelease { MRDC- |
| SecondaryCellGroupConfig } | OPTIONAL, -- Need M |
| radioBearerConfig2 | OCTET STRING |
| (CONTAINING RadioBearerConfig) | OPTIONAL, -- |

Need M

| | |
|---|---|
| sk-Counter | SK-Counter |

OPTIONAL, -- Need N

| | |
|---|---|
| nonCriticalExtension | RRCReconfiguration- |
| v1610-Ies | OPTIONAL |

}

| | |
|---|---|
| RRCReconfiguration-v1610-Ies ::= | SEQUENCE { |
| otherConfig-v1610 | OtherConfig-v1610 |

OPTIONAL, -- Need M

| | |
|---|---|
| bap-Config-r16 | SetupRelease { BAP- |
| Config-r16 } | OPTIONAL, -- Need M |
| iab-IP-AddressConfigurationList-r16 | IAB-IP- |
| AddressConfigurationList-r16 | OPTIONAL, -- |

```
  Need M
        conditionalReconfiguration-r16
  ConditionalReconfiguration-r16
  OPTIONAL, -- Need M
```

| | |
|---|---|
| daps-SourceRelease-r16 | ENUMERATED{true} |

OPTIONAL, -- Need N

| | |
|---|---|
| t316-r16 | SetupRelease {T316-r16} |

OPTIONAL, -- Need M

| | |
|---|---|
| needForGapsConfigNR-r16 | SetupRelease |
| {NeedForGapsConfigNR-r16} | OPTIONAL, -- Need M |
| onDemandSIB-Request-r16 | SetupRelease { OnDemandSIB- |
| Request-r16 } | OPTIONAL, -- Need M |
| dedicatedPosSysInfoDelivery-r16 | OCTET STRING (CONTAINING |
| PosSystemInformation-r16-Ies) | OPTIONAL, -- Need N |
| sl-ConfigDedicatedNR-r16 | SetupRelease {SL- |
| ConfigDedicatedNR-r16} | OPTIONAL, -- Need M |
| sl-ConfigDedicatedEUTRA-Info-r16 | SetupRelease {SL- |
| ConfigDedicatedEUTRA-Info-r16} | OPTIONAL, -- Need M |
| targetCellSMTC-SCG-r16 | SSB-MTC |

OPTIONAL, -- Need S

| | |
|---|---|
| nonCriticalExtension | RRCReconfiguration- |
| v1700-Ies | OPTIONAL |

}

| | |
|---|---|
| RRCReconfiguration-v1700-Ies ::= | SEQUENCE { |
| otherConfig-v1700 | OtherConfig-v1700 |

OPTIONAL, -- Need M

| | |
|---|---|
| sl-L2RelayUE-Config-r17 | SetupRelease { SL- |
| L2RelayUE-Config-r17 } | OPTIONAL, -- Need M |
| sl-L2RemoteUE-Config-r17 | SetupRelease { SL- |
| L2RemoteUE-Config-r17 } | OPTIONAL, -- Need M |
| dedicatedPagingDelivery-r17 | OCTET STRING (CONTAINING |
| Paging) | OPTIONAL, -- Cond PagingRelay |
| needForGapNCSG-ConfigNR-r17 | SetupRelease |
| {NeedForGapNCSG-ConfigNR-r17} | OPTIONAL, -- Need M |
| needForGapNCSG-ConfigEUTRA-r17 | SetupRelease |
| {NeedForGapNCSG-ConfigEUTRA-r17} | OPTIONAL, -- Need M |
| musim-GapConfig-r17 | SetupRelease {MUSIM- |
| GapConfig-r17} | OPTIONAL, -- Need M |
| ul-GapFR2-Config-r17 | SetupRelease { UL-GapFR2- |
| Config-r17 } | OPTIONAL, -- Need M |
| scg-State-r17 | ENUMERATED |
| { deactivated } | OPTIONAL, -- Need N |
| appLayerMeasConfig-r17 | AppLayerMeasConfig-r17 |

OPTIONAL, -- Need M

| | |
|---|---|
| ue-TxTEG-RequestUL-TDOA-Config-r17 | SetupRelease {UE-TxTEG- |
| RequestUL-TDOA-Config-r17} | OPTIONAL, -- Need M |
| nonCriticalExtension | RRCReconfiguration-v18xy |

OPTIONAL
}

| | |
|---|---|
| RRCReconfiguration-v18xy-Ies ::= | SEQUENCE { |
| ltm-CandidateConfig-r18 | SetupRelease {LTM- |
| CandidateConfig-r18} | OPTIONAL, -- Need M |
| nonCriticalExtension | SEQUENCE { } |

```
OPTIONAL
    }
    Radio resource control information elements:
    - LTM-CandidateConfig
    The IE LTM-CandidateConfig is used to provide LTM candidate cell
configuration.
    LTM-CandidateConfig information element:
    -- ASN1START
    -- TAG-LTM-CANDIDATECONFIG-START
```

| | |
|---|---|
| LTM-CandidateConfig-r18 ::= | SEQUENCE { |
| Lte-ReferenceConfiguration-r18 | OCTET STRING (CONTAINING |
| RRCReconfiguration) | OPTIONAL, -- Need N |
| ltm-CandidateToReleaseList-r18 | LTM-CandidateToReleaseList-r18 |

OPTIONAL, -- Need N

| | |
|---|---|
| ltm-CandidateToAddModList-r18 | LTM-CandidateToAddModList-r18 |

OPTIONAL, -- Need N

| | |
|---|---|
| ltm-candidatePartial-L2reset-Sets | SEQUENCE (SIZE (1..FFS)) OF |
| LTM-CandidatePartial-L2reset-Set-18 | OPTIONAL ... |

```
    }
    LTM-CandidateToReleaseList-r18::=SEQUENCE (SIZE (1..maxNrofCellsLTM-
```

| | |
|---|---|
| r18)) OF LTM-CandidateId-r18 | OPTIONAL, -- Need N |

```
    LTM-CandidateToAddModList-r18 ::= SEQUENCE (SIZE
(1..maxNrofCellsLTM-r18)) OF LTM-Candidate-r18
    LTM-CandidatePartial-L2reset-Set-18 ::= SEQUENCE (SIZE (1..FFS)) OF
LTM-CandidateId-r18
```

| | |
|---|---|
| LTM-Candidate-r18 ::= | SEQUENCE { |
| ltm-CandidateId-r18 | LTM-CandidateId-r18, |
| ltm-Config-r18 | OCTET STRING (CONTAINING |

```
RRCReconfiguration),
        ...
    }
    -- TAG-LTM-CANDIDATECONFIG-STOP
    -- ASN1STOP
```

ltm-CandidateConfig
Configuration of LTM candidate target SpCell(s), reference configuration
and sets of cells in which full L2 reset is not applied in LTL cell switch.
LTM-CandidateConfig field descriptions
ltm-ReferenceConfiguration
This field includes an RRCReconfiguration message used to configure a
reference configuration for LTM.
ltm-Config
This field includes an RRCReconfiguration message used to configure an
LTM candidate cell. This field can include only the CellGroupConfig IE,
RadioBearerConfig IE, and MeasConfig IE.
ltm-candidatePartial-L2reset-Sets
This field indicates the sets of candidate cells in which full L2 reset is not
performed upon LTM cell switch.

If the UE receives an RRC reconfiguration including LTM candidate configuration, then the UE performs the LTM configuration.

An example sequence for an LTM candidate configuration executed by the UE is given below (in the baseline CR for TS 38.331).

| | |
|---|---|
| 5.3.5.x | LTM configuration and execution |
| 5.3.5.x.1 | General |

```
      The UE shall perform the following actions based on a received LTM-
CandidateConfig IE:
  1> if the LTM-CandidateConfig includes the ltm-ReferenceConfiguration:
```

| | |
|---|---|
| 2> | perform the LTM reference configuration procedure as |

specified in 5.3.5.x.2;
1> if the LTM-CandidateConfig includes the ltm-CandidateToReleaseList:

| | |
|---|---|
| 2> | perform the LTM candidate cell release as specified in |

```
5.3.5.x.3;
  1> if the LTM-CandidateConfig includes the ltm-candidatePartial-
    L2reset-Sets:
```

| | |
|---|---|
| 2> | add the received ltm-candidatePartial-L2reset-Sets to |

VarLTM-Config;
2> if the LTM-CandidateConfig includes the ltm-CandidateToAddModList:

| | |
|---|---|
| 2> | perform the LTM candidate cell addition or reconfiguration |

as specified in 5.3.5.x.4;

| | |
|---|---|
| 5.3.5.x.2 | LTM reference configuration |

```
      The UE shall:
  1> if ltm-ReferenceConfiguration is set to “setup”:
```

| | |
|---|---|
| 2> | remove ltm-ReferenceConfiguration from VarLTM-Config, if |

```
stored;
      2> store the received ltm-ReferenceConfiguration in VarLTM-Config;
  1> else:
```

| | |
|---|---|
| 2> | remove ltm-ReferenceConfiguration from VarLTM-Config; |
| 5.3.5.x.3 | LTM candidate cell release |

```
      The UE shall:
  1> for each ltm-CandidateId in the ltm-CandidateToReleaseList:
```

| | |
|---|---|
| 2> | if the current VarLTM-Config includes an ltm-Candidate with |

the given ltm-CandidateId:

| | |
|---|---|
| 3> | release the ltm-Candidate from VarLTM-Config; |
| 5.3.5.x.4 | LTM candidate cell addition/modification |

```
      The UE shall:
  1> for each ltm-CandidateId in the ltm-CandidateToAddModList:
```

| | |
|---|---|
| 2> | if the current VarLTM-Config includes an ltm-Candidate with |

the given ltm-CandidateId:

| | |
|---|---|
| 3> | modify the ltm-Candidate within VarLTM-Config in accordance |

with the received ltm-Candidate;

| | |
|---|---|
| 2> | else: |
| 3> | add the received ltm-Candidate to VarLTM-Config. |
| 5.3.5.x.5 | Generation of UE LTM configuration |

```
      The purpose of this procedure is to generate a UE configuration to
be stored and applied only when an indication of an LTM cell switch is
received by lower layers.
      The UE shall:
  1> for each ltm-Candidate in ltm-CandidateConfigList within VarLTM-
    Config;
      2> store the ltm-CandidateId included in ltm-Candidate within
VarLTM-UE-Config;
      2> generate a UE configuration by applying the received ltm-
Candidate included within ltm-CellGroupConfigList to the
referenceConfiguration (if any) and store it in ue-LTM-Config within
VarLTM-UE-Config.
```

| | |
|---|---|
| 5.3.5.x.5 | LTM cell switch execution |

```
      Upon the indication by lower layers that an LTM cell switch
procedure is triggered, the UE shall:
  1> apply the UE LTM configuration in UE-LTM-Config within VarLTM-UE-
    Config related to the LTM candidate cell configuration identity as
    received by lower layers.
```

UE variables:

### VarLTM-Config

The IE VarLTM-Config is used to store the reference configuration and one or more LTM candidate cell configurations.

```
    VarLTM-Config UE variable
      -- ASN1START
      -- TAG-VARLTM-CONFIG-START
      VarLTM-Config-r18-IEs ::= SEQUENCE {
```

| | |
|---|---|
| ltm-ReferenceConfiguration-r18 | OCTET STRING (CONTAINING |

RRCReconfiguration),

| | |
|---|---|
| ltm-CandidateList-r18 | LTM-CandidateList-r18, |
| ltm-candidatePartial-L2reset-Sets-18 | SEQUENCE (SIZE (1..FFS)) |

```
  OF LTM-CandidatePartial-L2reset-Set-18
      }
      LTM-CandidateList-r18 ::= SEQUENCE (SIZE (1..maxNrofCellsLTM-r18))
  OF LTM-Candidate-r18
      -- TAG-VARLTM-CONFIG-STOP
      -- ASN1STOP
      - VarLTM-UE-Config
    The IE VarLTM-UE-Config is used to store the generated UE configuration related
to the received LTM candidate cell configurations.
    VarLTM-UE-Config UE variable
        -- ASN1START
        -- TAG-VARLTM-CONFIG-START
        VarLTM-UE-Config-r18-IEs ::= SEQUENCE {
```

| | |
|---|---|
| Ue-ltm-ConfigCandidateList-r18 | UE-LTM- |

```
  ConfigCandidateList-r18
        }
        UE-LTM-ConfigCandidateList-r18 ::= SEQUENCE (SIZE
  (1..maxNrofCellsLTM-r18)) OF UE-LTM-Config-r18
```

| | |
|---|---|
| UE-LTM-Candidate-r18 ::= | SEQUENCE { |
| ltm-CandidateId-r18 | LTM-CandidateId-r18, |
| ue-LTM-Config-r18 | OCTET STRING, |

```
        }
        -- TAG-VARLTM-CONFIG-STOP
        -- ASN1STOP
```

Dual Connectivity:

Dual connectivity or more technically multi-radio dual connectivity is specified by 3GPP in specifications such as TS 37.340. A summary of the details on dual connectivity and measurement gap operations with dual connectivity are given below.

Next Generation-Radio Access Network (NG-RAN) supports Multi-Radio Dual Connectivity (MR-DC) operation, where a user equipment (UE) in the RRC_CONNECTED state is configured to utilize radio resources provided by two distinct schedulers, located in two different NG-RAN nodes. The distinct schedulers, located in two different NG-RAN nodes are connected via a non-ideal backhaul, one providing NR access and the other one providing either Evolved UMTS Terrestrial Radio Access (E-UTRA) or NR access. One node acts as a Master Node (MN) and the other as a Secondary Node (SN). The MN and SN are connected via a network interface and at least the MN is connected to the core network. NG-RAN supports NG-RAN E-UTRA-NR Dual Connectivity (NGEN-DC), in which a UE is connected to one NG-eNB (a E-UTRA base station that can connect to 5G core) that acts as MN and one Gnb (5G base station) that acts as SN. NG-RAN also supports NR-E-UTRA Dual Connectivity (NE-DC), in which a UE is connected to one gNB that acts as MN and one NG-eNB that acts as SN.

Primary Secondary Cell (PSCell) change and PSCell Addition:

PSCell change can occur due to mobility and may or may not be associated with the SN Change. The SN change procedure is initiated either by MN or SN and used to transfer a UE context from a source SN to a target SN and to change the SCG (Secondary Cell Group) configuration in UE from one SN to another.

A Conditional PSCell Change (CPC) is defined as a PSCell change that is executed by the UE when execution condition(s) is met. The UE may be configured with execution condition and RRC messages like RRC Reconfiguration for executing when the conditions are met for one or more of candidate cells. The UE starts evaluating the execution condition(s) upon receiving the CPC configuration, and stops evaluating the execution condition(s) once PSCell change is triggered. Intra-SN CPC without MN in-volvement, inter-SN CPC initiated either by MN or SN are supported.

The following principles apply to CPC:
a. The CPC configuration contains the configuration of CPC candidate PSCell(s) and execution condition(s) and may contain the MN configuration for inter-SN CPC.
b. An execution condition may consist of one or two trigger condition(s) (CPC events A3/A5, as defined in TS 38.331 [4]). Only single RS type is supported and at most two different trigger quantities (e.g. RSRP and RSRQ, RSRP and SINR, etc.) can be configured simultaneously for the evaluation of CPC execution condition of a single candidate PSCell.
c. Before any CPC execution condition is satisfied, upon reception of PSCell change command or Primary Cell (PCell) change command, the UE executes the PSCell change procedure as described in clause 10.3 and 10.5 or the PCell change procedure as described in clause 9.2.3.2 in TS 38.300[3] or clause 10.1.2.1 in TS 36.300 [2], re-gardless of any previously received CPC configuration. Upon a successful completion of PSCell change procedure or PCell change procedure, the UE releases all stored CPC configurations.
d. While executing CPC, the UE is not required to continue evaluating the execution condition of other candidate PSCell(s).
e. Once the CPC procedure is executed successfully, the UE releases all stored CPC configurations.
f. Upon the release of SCG, the UE releases the stored CPC configurations.

3GPP release 18 enhances the CPC through selective activation of cell groups where the UE doesn't release the stored CPC configuration for one or more candidate PSCells and the source PSCell based on network's inputs.

MN adds PSCell during a PSCell addition procedure. A PSCell addition procedure that is executed only when PSCell addition condition(s) are met is called Conditional PSCell Addition (CPA).

For a UE in dual connectivity, both MN and SN can provide the LTM configuration including LTM candidate cells, LTM reference configuration. MN and SN may also provide the LTM measurement configurations to the UE.

Measurements in dual connectivity:

Measurements in dual connectivity can be described based on 3GPP specification TS 37.340, V17.2.0.

Measurements can be configured independently by the MN and by the SN (intra-RAT measurements on serving and non-serving frequencies). The MN indicates maximum number of frequency layers and measurement identities of intra-frequency and inter-frequency measurement that can be used in the SN to ensure that UE capa-bilities are not exceeded. In the measurement type, the SN indicates to the MN the list of SCG serving frequencies. In NR-DC, to assist SN to identify the measurement type, the MN indicates also to SN, the list of MCG (Master Cell Group) serving frequencies. The SN can also request the MN for new maximum values of the number of measurement identities that the SN can configure, and it is up to the MN whether to ac-commodate the SN request, based on the capability coordination principles as described in section 7.3 of TS 37.340. If the SN receives a new value, from the MN, for the maximum number of measurement identities, then the new value is SN respon-sibility to ensure that it's configured measurement identities to comply with the new limit.

If MN and SN both configure measurements on the same carrier frequency, then the configurations need to be consistent (if the network wants to ensure these are considered as a single measurement layer). Each node (MN and SN) can configure independently a threshold for the SpCell quality. In (NG) EN-DC scenario, when the PCell quality is above the threshold configured by the MN, the UE is still required to perform inter-RAT measurements configured by the MN on the SN RAT (while it's not required to perform intra-RAT measurements); when the PSCell quality is above the threshold configured by the SN, the UE is not required to perform measurements configured by the SN. In NR-DC or NE-DC scenario, when the PCell quality is above the threshold configured by the MN, the UE is not required to perform measurements configured by the MN; when the PSCell quality is above the threshold configured by the SN, the UE is not required to perform measurements configured by the SN.

In MR-DC, both the MN and the SN can configure CGI reporting. The MN can configure CGI reporting for intra-RAT and inter-RAT cells, but the SN can only configure CGI reporting of intra-RAT cells. At any point in time, the UE can be configured with at most one CGI reporting configuration. For CGI reporting coordination, the SN sends the CGI measurement request and the embedded CGI reporting configuration to the MN. Optionally, the SN sends the unknown cell information to the MN. If there is no ongoing CGI reporting measurement on UE side, then the MN forwards the SN CGI measurement configuration to UE. Else, the MN rejects the request by sending X2/Xn reject message. In case the SN indicates the unknown cell information, and the CGI information of the requested cell is already available in the MN, the MN can also reject the request, and send the CGI information of the requested cell to the SN. The SN cannot configure the CGI measurement using the Signaling Radio Bearer 3 (SRB3).

Both MN-configured and SN-configured Radio resource management (RRM) measurements are supported while the SCG is deactivated. The PSCell measurement cycle when in deactivated SCG state is configured by RRC.

When SRB3 is not configured or the SCG is deactivated, reports for measurements configured by the SN are sent on SRB1. When SRB3 is configured and SCG transmission of radio bearers is not suspended and the SCG is not deactivated, reports for measurements configured by the SN are sent on SRB3.

Measurement results related to the target SN can be provided by MN to target SN at MN initiated SN change procedure. Measurement results of target SN can be forwarded from source SN to target SN via MN at SN initiated SN change procedure. Measurement results related to the target SN can be provided by source MN to target MN at Inter-MN handover with/without SN change procedure.

Measurement results according to measurement configuration from the MN are encoded according to SN RRC when they are provided by MN to SN in SgNB Addition Request message/SN Addition Request message. During SN initiated SN change procedure, measurement results according to measurement configuration from SN are encoded according to SN RRC when they are provided by MN to SN in SgNB Addition Request message/SN Addition Request message.

Per-UE or per-FR measurement gaps can be configured, depending on UE capability to support independent Frequency Range (FR) measurement and network preference. Per-UE gap applies to both FR1 (E-UTRA, UTRA-FDD and NR) and FR2 (NR) frequencies. For per-FR gap, two independent gap patterns (for example, FR1 gap and FR2 gap) are configured for FR1 and FR2 respectively. The UE may also be configured with a per-UE gap sharing configuration (applying to per-UE gap) or with two separate gap sharing configurations (applying to FR1 and FR2 measurement gaps respectively).

If per-UE gap is used, then the MN decides the gap pattern and the related gap sharing configuration. If per-FR gap is used, in EN-DC and NGEN-DC, then the MN decides the FR1 gap pattern and the related gap sharing configuration for FR1, while the SN decides the FR2 gap pattern and the related gap sharing configuration for FR2; in NE-DC and NR-DC, the MN decides both the FR1 and FR2 gap patterns and the related gap sharing configurations.

In EN-DC and NGEN-DC, the measurement gap configuration from the MN to the UE indicates if the configuration from the MN is a per-UE gap or an FR1 gap configuration. The MN also indicates the configured per-UE or FR1 measurement gap pattern and the gap purpose (per-UE or per-FR1) to the SN. Measurement gap configuration assistance information can be exchanged between the MN and the SN. For the case of per-UE gap, the SN indicates to the MN the list of SN configured frequencies in FR1 and FR2 measured by the UE. For the per-FR gap case, the SN indicates, to the MN, the list of SN configured frequencies in FR1 measured by the UE; and the MN indicates, to the SN, the list of MN configured frequencies in FR2 measured by the UE. In NE-DC, the MN indicates the configured per-UE or FR1 measurement gap pattern to the SN. The SN can provide a gap request to the MN, without indicating any list of frequencies.

In NR-DC, the MN indicates the configured per-UE, FR1 or FR2 measurement gap pattern and the gap purpose to the SN. The SN can indicate the list of SN configured frequencies in FR1 and FR2 measured by the UE, to the MN. In (NG) EN-DC and NR-DC, SS/PBCH Block Measurement Timing Configuration (SMTC) can be used for PSCell addition/PSCell change to assist the UE in finding the SSB in the target PSCell. In case, if the SMTC of the target PSCell is provided by both the MN and the SN, then it is up to the UE implementation which one to use.

Hence, there is a need in the art for solutions for managing the LTM when dual connectivity is configured.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

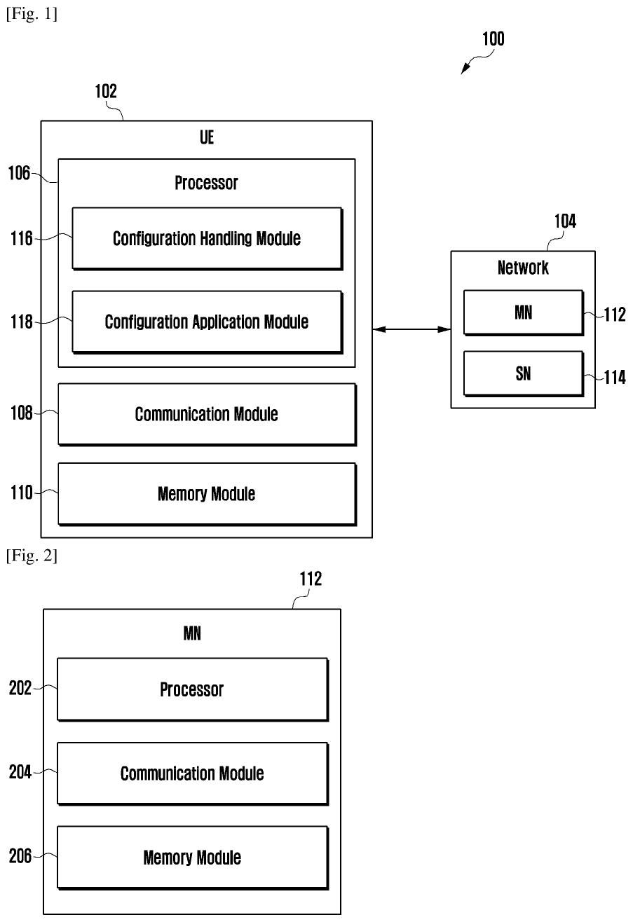

The embodiments herein provide methods and systems for managing a Lower-layer Triggered Mobility (LTM) in New Radio-Dual Connectivity (NR-DC) and handling one or more UE variables for the LTM. Referring now to the drawings, and more particularly to FIGS. 1 through 8, where similar reference characters denote corresponding features consistently throughout the figures, there are shown embodiments.

FIG. 1 illustrates a system 100 for managing a Lower-layer Triggered Mobility (LTM) in NR-DC. The system 100 comprises a User Equipment (UE) 102, and a network 104. In an embodiment herein, the UE 102 can perform procedures for LTM configuration and execution for the LTM configuration associated with one or more cell groups for which the procedures are instructed by a base station (gNB). The UE 102 comprises a processor 106, a communication module 108, and a memory module 110. The network 104 comprises a Master Node (MN) 112 and a Secondary Node (SN) 114.

In an embodiment herein, the processor 106 can receive a LTM configuration from both the MN 112 and the SN 114 in dual connectivity, including methods for handling one or more configurations for LTM. The processor 106 can map the LTM configuration to a Master Cell Group (MCG) and a Secondary Cell Group (SCG). The processor 106 can store the LTM configuration and apply the LTM configuration. The processor 106 further comprises a configuration handling module 116, and a configuration applicable module 118.

In an embodiment herein, the configuration handling module 116 can receive at least one LTM configuration from the network 104. The LTM configuration can be received from at least one of the MN 112 via a Signaling Radio Bearer 1 (SRB1), and the SN 114 via a SRB3. The LTM configuration can be received through at least one of the following, included in a MN Radio Resource Control (RRC) reconfiguration message received via SRB1 from the MN 112, included in a SN RRC reconfiguration message received via SRB3 from the SN 114, and included in the SN RRC reconfiguration message and embedded in the MN RRC reconfiguration message received via SRB1 from the MN 112.

The configuration handling module 116 can associate the LTM configuration to at least one cell group, for example, at least one of the MCG, the SCG, and so on. The configuration handling module 116 can associate the LTM configuration, based on how the LTM configuration is received i.e., based on receiving from at least one of the MN 112 and the SN 114. The LTM configuration can be, but not limited to at least one of a LTM candidate configuration, an LTM reference configuration, an LTM measurement configuration, ltm-candidatePartial-L2reset-Sets, and other LTM related configurations. The configuration handling module 116 can maintain the received LTM configuration for each associated cell group independently. The configuration handling module 116 can maintain LTM configurations, for example, in one or more UE variables.

In an embodiment herein, the configuration handling module 116 can maintain two independent LTM configurations, one for MCG and one for SCG, for LTM related operations. In an embodiment herein, the configuration handling module 116 can maintain two sets of independent UE variables, one for MCG and one for SCG, for LTM related operations.

In an embodiment herein, the configuration handling module 116 can maintain two independent LTM configurations, one for MCG and one for SCG, for LTM related operations.

In an embodiment herein, the configuration handling module 116 can maintain two independent UE variables (or two independent LTM configurations), one for MCG and one for SCG, for storing the LTM reference configuration and LTM candidate cell configurations as well as the configuration such as the set of cells where L2 partial reset can be performed or the set of cells which could be stored for further LTM operations. For example, the configuration handling module 116 can maintain two independent UE variables such as VarLTM-Config, one each for MCG and SCG. In an embodiment herein, the configuration handling module 116 can maintain two independent UE variables (or two independent LTM configurations), one each for MCG and one for SCG, to store a UE configuration which is generated related to the received LTM candidate cell configurations. For example, the UE 102 maintains two independent UE variables, for example VarLTM-UE-Config, one each for the MCG and the SCG.

In an embodiment herein, the configuration handling module 116 can maintain a single LTM configuration (or UE variable), for both the MCG and the SCG, for storing the LTM reference configuration and the LTM candidate cell configurations as well as the configuration such as the set of cells where L2 partial reset can be performed. For example, the configuration handling module 116 can maintain a single UE variable for example, VarLTM-Config, for both the MCG and the SCG i.e., the set of cells which could be stored for further LTM operations. In an embodiment herein, the configuration handling module 116 can maintain a single UE variable, for both the MCG and the SCG, to store the UE configuration which is generated related to the received LTM candidate cell configuration. For example, the configuration handling module 116 can maintain a single UE variable for VarLTM-UE-Config, for both the MCG and the SCG.

In an embodiment herein, the configuration handling module 116 can maintain a first LTM configuration, and a second LTM configuration. The configuration handling module 116 allots the first LTM configuration (or UE variable) for the MCG, and the second LTM configuration (or UE variable) for the SCG. For example, the first UE variable, and the second UE variable corresponding to the LTM configuration is VarLTM-UE-Config.

In an embodiment herein, the configuration handling module 116 can receive the LTM configuration (for example, LTM candidate configuration) which is associated with the MCG from the MN 112, except when the LTM configuration is implicitly or explicitly associated with the SCG. The configuration handling module 116 can receive the LTM configuration which is associated with the MCG from the MN 112 in the MN RRC reconfiguration message via the SRB1. The LTM configuration can be a LTM candidate configuration.

In an embodiment herein, the configuration handling module 116 can receive the LTM configuration which is associated with the SCG from the SN 114. The configuration handling module 116 can receive the LTM configuration which is associated with the SCG from the SN 114 in the SN RRC reconfiguration message via the SRB3. The LTM configuration can be a LTM candidate configuration.

In an embodiment herein, the configuration handling module 116 can receive the LTM configuration which is associated with the SCG from the MN 112, where the LTM configuration is received by implicit association with the SCG from the MN 112 if the LTM configuration is generated by the SN 114. The configuration handling module 116 can receive the LTM configuration which is associated with the SCG (generated by SN 114) from the MN 112 in the SN RRC reconfiguration message embedded in the MN RRC reconfiguration message via SRB1. The MN 112 receives the LTM configuration which is associated with the SCG from the SN 114. The LTM configuration can be a LTM candidate configuration.

In an embodiment herein, the configuration handling module 116 can receive a RRC message for updating the LTM configuration. The configuration handling module 116 can identify the associated cell group of the LTM configuration, on receiving the RRC message. The configuration handling module 116 can update at least one LTM configuration (or UE variable) which is associated with at least one cell group. For example, updating the LTM configuration can comprise at least one of setting up the LTM configuration, releasing the LTM configuration, modifying the LTM configuration, and generating a UE configuration related to the received LTM configuration.

In an embodiment herein, for NR-DC, the configuration handling module 116 can receive two independent LTM candidate configurations (for example, ltm-CandidateConfig). One LTM candidate configuration is associated with the MCG, and one LTM candidate configuration is associated with the SCG.

In an embodiment herein, the configuration application module 118 can configure the received LTM configuration for the associated cell group for performing at least one LTM operation for each associated cell group independently. In an embodiment herein, the configuration application module 118 can perform simultaneous configuration of the LTM configuration for both the MN 112 and the SN 114. Further, the LTM operation can comprise a LTM cell switch.

In an embodiment herein, upon receiving a RRC message such as a RRC reconfiguration message for updating the LTM configuration or the LTM configuration associated with a cell group, or performing any other action (for example, autonomous update of configuration) for updating the LTM configuration associated with a cell group, the UE 102 updates the UE variables VarLTM-Config (or equivalent UE variable for storing the LTM reference configuration and the LTM candidate cell configurations as well as the configuration such as the set of cells where L2 partial reset can be performed or the set of cells which could be stored for further LTM operations), and VarLTM-UE-Config (or equivalent UE variable for storing the generated UE configuration related to the received LTM candidate cell configurations) associated with the same cell group.

In an embodiment herein, the gNB (for example, from MN 112) can exclude configuring dual connectivity and LTM together. If the UE 102 is configured with the dual connectivity and gNB (for example, from MN 112) decides to configure the LTM, then the gNB releases the SCG and configures the LTM. If the UE 102 is configured with LTM and gNB (MN 112) decides to configure dual connectivity, then the gNB releases the LTM configuration and configures the SCG.

In an embodiment herein, both the MN 112 and the SN 114 can configure the UE 102 for LTM simultaneously. In an alternative embodiment, only one of the MN 112 and the SN 114 can configure LTM at a time. The MN 112 can inform the SN 114, once the MN 112 has configured LTM to the UE 102. The MN 112 can inform the SN 114, once the LTM has not been configured to the UE 102, for example if the LTM configuration is released. The SN 114 can inform the MN 112, once the SN 114 has configured LTM to the UE 102. The SN 114 can inform the MN 112, once the LTM has not been configured to the UE 102, for example if the LTM configuration is released. In an embodiment herein, the MN 112 can inform the SN 114 the above information through InterNode RRC message like CG-Config. 1n an embodiment herein, the SN 114 can inform the MN 112, the above information through InterNode RRC message like CG-ConfigInfo.

In an alternate embodiment, the MN 112 can inform the SN 114 if the MN 112 can configure LTM, i.e., the MN 112 controls the SN configuration of LTM. In an embodiment herein, the MN 112 can inform the SN 114, the above information of whether the MN 112 can configure LTM, through an InterNode RRC message such as CG-ConfigInfo.

In an embodiment herein, for E-UTRA-NR Dual Connectivity (EN-DC), the VarLTM-Config and the VarLTM-UE-Config are associated with the SCG.

In an embodiment herein, in NR-E-UTRA Dual Connectivity (NE-DC), the VarLTM-Config (or equivalent variables for storing the LTM reference configuration and the LTM candidate cell configurations as well as the configuration such as the set of cells where L2 partial reset can be performed or the set of cells which could be stored for further LTM operations) and VarLTM-UE-Config (or equivalent UE variable to store the generated UE configuration related to the received LTM candidate cell configurations) are associated with the MCG.

In an embodiment herein, in NR-DC or any other type of DC when no SCG is configured, the VarLTM-Config (or equivalent variables for storing the LTM reference configuration and the LTM candidate cell configurations as well as the configuration such as the set of cells where L2 partial reset can be performed or the set of cells which could be stored for further LTM operations) and VarLTM-UE-Config (or equivalent UE variable to store the UE configuration which is generated related to the received LTM candidate cell configurations) are associated with the MCG.

In an embodiment herein, the MN 112 and the SN 114 can allocate the same candidate cell id for LTM candidate cells, for same or different cells.

In an embodiment herein, when a single LTM configuration is associated with both the MCG and the SCG, and upon the occurrence of event such as reception of RRC message or any other event associated with a cell group, the UE 102 updates the LTM configuration and generated LTM configuration associated to the cell group.

In an embodiment herein, if the UE 102 receives LTM candidate configuration from the SN 114 in a RRC message such as RRC reconfiguration message, then the UE 102 performs LTM configuration and execution procedure for SCG. In an embodiment herein, if the UE 102 receives LTM configuration (for example, LTM candidate configuration) from the SN 114 in a RRC message such as RRC reconfiguration message and the LTM candidate configuration includes a configuration to add (i.e., setup) the LTM reference configuration, then the UE 102 adds (i.e., sets up) the received LTM reference configuration in the VarLTM-Config (or similar UE variable for storing the LTM reference configuration) associated with the SCG. In the above scenario, the UE 102 also releases the generated UE configuration (if any, generated using a previously received LTM reference configuration) related to the received LTM candidate cell configurations stored in the corresponding UE variable (for example, VarLTM-UE-Config) associated with the SCG, and generates a new UE configuration for all the applicable LTM candidate cells and store in the corresponding UE variable (for example, VarLTM-UE-Config) associated with the SCG.

In an embodiment herein, if the UE 102 receives LTM configuration (for example, the LTM candidate configuration) from the SN 114 in a RRC message such as RRC reconfiguration message and the LTM candidate configuration includes a configuration to modify LTM reference configuration. The UE 102 modifies the received LTM reference configuration in the VarLTM-Config (or similar UE variable for storing the LTM reference configuration) associated with the SCG. In the above scenario, the UE 102 also releases the generated UE configuration (if any, generated using a previously received LTM reference configuration) related to the received LTM candidate cell configurations stored in the corresponding UE variable (for example, VarLTM-UE-Config) associated with the SCG, generates a new UE configuration for all the applicable LTM candidate cells, and stores the UE configuration in the corresponding UE variable (for example, VarLTM-UE-Config).

In an embodiment herein, if the UE 102 receives the LTM configuration (for example, LTM candidate configuration) from the SN 114 in a RRC message such as RRC Reconfiguration and the LTM candidate configuration includes a configuration to release LTM reference configuration, then the UE 102 releases the received LTM reference configuration in the VarLTM-Config (or similar UE variable for storing LTM reference configuration) associated with the SCG. In the above scenario, the UE 102 also releases the generated UE configuration (if any, generated using a previously received LTM reference configuration) related to the received LTM candidate cell configurations stored in the corresponding UE variable (for example, VarLTM-UE-Config) associated with the SCG.

In an embodiment herein, if the UE 102 receives the LTM configuration (for example, LTM candidate configuration) from the SN 114 in a RRC message such as RRC Reconfiguration and the LTM candidate configuration includes a configuration to release LTM candidate cell, (for example, including LTM candidate cell index, such as ltm-Candidateld), then the UE 102 releases the received LTM candidate cell in the VarLTM-Config (or similar UE variable) associated with the SCG.

In an embodiment herein, if the UE 102 receives the LTM configuration (for example, LTM candidate configuration) from the SN 114 in a RRC message such as RRC Reconfiguration and the LTM candidate configuration includes a configuration to add (i.e., setup) LTM candidate cell, (for example including LTM candidate cell index, such as ltm-Candidateld), then the UE 102 adds the received LTM candidate cell in the VarLTM-Config (or similar UE variable) associated with the SCG.

In an embodiment herein, if the UE 102 receives the LTM configuration (for example, LTM candidate configuration) from the SN 114 in a RRC message such as RRC Reconfiguration and the LTM candidate configuration includes a configuration to release LTM candidate cell, (for example, including LTM candidate cell index, such as ltm-Candidateld), then the UE 102 releases the LTM candidate cell in the VarLTM-Config (or similar UE variable) associated with the SCG. In the above scenario, the UE 102 also releases the generated UE configuration related to the received LTM candidate cell configurations stored in the corresponding UE variable (for example, VarLTM-UE-Config) associated with the SCG.

In an embodiment herein, if the UE 102 receives the LTM configuration (for example, LTM candidate configuration) from the SN 114 in a RRC message such as RRC Reconfiguration and the LTM candidate configuration includes a configuration to add (i.e., setup) LTM candidate cell, (for example, including LTM candidate cell index, such as ltm-Candidateld), then the UE 102 adds the received LTM candidate cell in the VarLTM-Config (or similar UE variable) associated with the SCG. In the above scenario, the UE 102 also generates UE configuration related to the received LTM candidate cell configurations and stores in the corresponding UE variable (for example, VarLTM-UE-Config) associated with the SCG.

In an embodiment herein, if the UE 102 receives the LTM configuration (for example, LTM candidate configuration) from the SN 114 in a RRC message such as RRC Reconfiguration and the LTM candidate configuration includes a configuration to release the sets of candidate cells in which full L2 reset is not performed upon LTM cell switch or to release one candidate cell from the set of candidate cells in which full L2 reset is not performed upon LTM cell switch, then the UE 102 releases the received sets of candidate cells in which full L2 reset is not performed upon LTM cell switch (or to release one candidate cell from the set of candidate cells in which full L2 reset is not performed upon LTM cell switch, in case it is received to be released) in the VarLTM-Config (or similar UE variable) associated with the SCG.

In an embodiment herein, if the UE 102 receives the LTM configuration (for example, LTM candidate configuration) from the SN 114 in a RRC message such as RRC reconfiguration and the LTM candidate configuration includes a configuration to add the sets of candidate cells in which full L2 reset is not performed upon LTM cell switch or to release one candidate cell from the set of candidate cells in which full L2 reset is not performed upon LTM cell switch, then the UE 102 adds or releases the received sets of candidate cells in which full L2 reset is not performed upon LTM cell switch (or to release one candidate cell from the set of candidate cells in which full L2 reset is not performed upon LTM cell switch, in case the candidate cell is received to be released) in the VarLTM-Config (or similar UE variable) associated with the SCG.

In an embodiment herein, the LTM configuration (for example, LTM candidate configuration) received from the MN 112 is associated with the MCG, except when the MN 112 is implicitly or explicitly associated with an SCG.

In an embodiment herein, the LTM configuration received from the MN 112 is explicitly associated with the MCG by including an IE in RRC messages such as RRC Reconfiguration or RRC Resume which is used only for providing the LTM configuration for the MCG. In an embodiment herein, the LTM configuration received from the MN 112 is explicitly associated with the MCG by including an IE (flag/index which points to MCG/enumerated pointing to MCG etc.) in RRC messages such as RRC Reconfiguration or RRC Resume which informs the UE 102 that the configuration is associated with the MCG.

In an embodiment herein, the LTM candidate configuration received from the MN 112 is associated with the SCG by implicit association if the LTM candidate configuration is included within a RRC reconfiguration message (generated by the source SN 114) and embedded in a RRC reconfiguration message sent from the MN 112. In an embodiment herein, the LTM configuration received from the MN 112 is explicitly associated with the SCG by including an IE in RRC messages such as RRC Reconfiguration or RRC Resume which is used only for providing the LTM configuration for SCG. In an embodiment herein, the LTM configuration received from the MN 112 is explicitly associated with the SCG by including an IE (flag/index which points to SCG/enumerated pointing to SCG etc.) in RRC messages such as RRC Reconfiguration or RRC Resume which informs the UE 102 that the configuration is associated with the SCG.

In an alternate embodiment herein, the LTM candidate configuration received from the MN 112 is associated with MCG only and not to SCG.

In the above embodiments, if the LTM configuration for MCG and SCG are stored in the same UE variable (for example, one VarLTM-Config and/or one VarLTM-UE-Config) for both MCG and SCG, then the UE 102 identifies the configurations associated to SCG and performs the respective operation as in the above embodiments (adds/modifies/performs setup/releases the LTM configuration).

In an embodiment herein, if the UE 102 receives the LTM candidate configuration from the MN 112 in a RRC message such as RRC reconfiguration message and the LTM configuration is associated with the MCG, then the UE 102 performs the LTM configuration and execution procedure for MCG. In an embodiment herein, if the UE 102 receives LTM configuration (for example, LTM candidate configuration) from the MN 112 and the LTM configuration is associated with the MCG, in a RRC message such as a RRC reconfiguration message and the LTM candidate configuration includes a configuration to add (i.e., setup) LTM reference configuration, then the UE 102 adds (i.e., sets up) the received LTM reference configuration in the VarLTM-Config (or similar UE variable) associated with the MCG. In the above scenario, the UE 102 also releases the generated UE configuration (if any, generated using a previously received LTM reference configuration) related to the received LTM candidate cell configurations stored in the corresponding UE variable (for example, VarLTM-UE-Config) associated with the MCG and generates a new UE configuration for all the applicable LTM candidate cells and stores in the corresponding UE variable (for example, VarLTM-UE-Config) associated with the MCG.

In an embodiment herein, if the UE 102 receives the LTM configuration (for example, LTM candidate configuration) from the MN 112 and the LTM configuration is associated with the MCG in a RRC message such as RRC reconfiguration message and the LTM candidate configuration includes a configuration to modify the LTM reference configuration, then the UE 102 modifies the received LTM reference configuration in the VarLTM-Config (or similar UE variable) associated with the MCG. In the above scenario, the UE 102 also releases the generated UE configuration (if any, generated using a previously received LTM reference configuration) related to the received LTM candidate cell configurations stored in the corresponding UE variable (for example, VarLTM-UE-Config) associated with the MCG, and generates a new UE configuration for all the applicable LTM candidate cells and stores in the corresponding UE variable (for example, VarLTM-UE-Config) associated with the MCG.

In an embodiment herein, if the UE 102 receives the LTM configuration (for example, LTM candidate configuration) from the MN 112 and the LTM configuration is associated with the MCG, in a RRC message such as RRC Reconfiguration and the LTM candidate configuration includes a configuration to release LTM reference configuration, then the UE 102 releases the received LTM reference configuration in the VarLTM-Config (or similar UE variable n) associated with the MCG. In the above scenario, the UE 102 also releases the generated UE configuration (if any, generated using a previously received LTM reference configuration) related to the received LTM candidate cell configurations stored in the corresponding UE variable (for example, VarLTM-UE-Config) associated with the MCG.

In an embodiment herein, if the UE 102 receives the LTM configuration (for example, LTM candidate configuration) from the MN 112 and the LTM configuration is associated with the MCG in a RRC message such as RRC reconfiguration message and the LTM candidate configuration includes a configuration to release LTM candidate cell, (for example, including LTM candidate cell index, such as ltm-CandidateId), then the UE 102 releases the received LTM candidate cell in the VarLTM-Config (or similar UE variable) associated with the MCG.

In an embodiment herein, if the UE 102 receives the LTM configuration (for example, LTM candidate configuration) from the MN 112 in a RRC message such as RRC reconfiguration and the LTM configuration is associated with MCG, and the LTM candidate configuration includes a configuration to add (i.e. setup) LTM candidate cell, (for example, including LTM candidate cell index, such as ltm-CandidateId), then the UE 102 adds the received LTM candidate cell in the VarLTM-Config (or similar UE variable) associated with the MCG.

In an embodiment herein, if the UE 102 receives the LTM configuration (for example, LTM candidate configuration) from the MN 112 in a RRC message such as RRC Reconfiguration and the LTM configuration is associated with the MCG and the LTM candidate configuration includes a configuration to release LTM candidate cell, (for example, including LTM candidate cell index, such as ltm-Candidateld), then the UE 102 releases the generated LTM candidate cell in the VarLTM-Config (or similar UE variable) associated with the MCG. In the above scenario, the UE 102 also releases the generated UE configuration related to the received LTM candidate cell configurations stored in the corresponding UE variable (for example, VarLTM-UE-Config) associated with the MCG.

In an embodiment herein, if the UE 102 receives LTM configuration (for example, LTM candidate configuration) from the MN 112 in a RRC message such as RRC Reconfiguration and the LTM configuration is associated with the MCG and the LTM candidate configuration includes a configuration to add (i.e., setup) LTM candidate cell, (for example, including LTM candidate cell index, such as ltm-Candidateld), then the UE 102 adds the received LTM candidate cell in the VarLTM-Config (or similar UE variable) associated with the MCG. In the above scenario, the UE 102 also generates UE configuration related to the received LTM candidate cell configurations, and stores in the corresponding UE variable (for example VarLTM-UE-Config) associated with the MCG.

In an embodiment herein, if the UE 102 receives the LTM configuration (for example, LTM candidate configuration) from the MN 112 in a RRC message such as RRC Reconfiguration and the LTM configuration is associated with the MCG, and the LTM candidate configuration includes a configuration to release the sets of candidate cells in which full L2 reset is not performed upon LTM cell switch or to release one candidate cell from the set of candidate cells in which full L2 reset is not performed upon LTM cell switch, then the UE 102 releases the received sets of candidate cells in which full L2 reset is not performed upon LTM cell switch (or to release one candidate cell from the set of candidate cells in which full L2 reset is not performed upon LTM cell switch, in case it is received to be released) in the VarLTM-Config (or similar UE variable) associated with the MCG.

In an embodiment herein, if the UE 102 receives the LTM configuration (for example, LTM candidate configuration) from the MN 112 in a RRC message such as RRC Reconfiguration and the LTM candidate configuration includes a configuration to add the sets of candidate cells in which full L2 reset is not performed upon LTM cell switch or to release one candidate cell from the set of candidate cells in which full L2 reset is not performed upon LTM cell switch, then the UE 102 adds the received sets of candidate cells in which full L2 reset is not performed upon LTM cell switch (or to release one candidate cell from the set of candidate cells in which full L2 reset is not performed upon LTM cell switch, in case it is received to be released) in the VarLTM-Config (or similar UE variable) associated with the MCG.

In the above embodiments, if the LTM configuration for MCG and SCG are stored in the same UE variable (for example, one VarLTM-Config and/or one VarLTM-UE-Config) for both MCG and SCG, then the UE 102 identifies the configurations associated to MCG and performs the respective operation as in the above embodiments (adds/modifies/performs setup/release the LTM configuration).

In an embodiment herein, if the UE 102 receives the LTM candidate configuration from the MN 112 in a RRC message such as RRC reconfiguration and the configuration is associated with SCG, then the UE 102 performs the LTM configuration and execution procedure for SCG. In an embodiment herein, if the UE 102 receives the LTM configuration (for example, LTM candidate configuration) from the MN 112 and the configuration is associated with SCG, in a RRC message such as RRC reconfiguration and the LTM candidate configuration includes a configuration to add (i.e. setup) LTM reference configuration, then the UE 102 adds (i.e., sets up) the received LTM reference configuration in the VarLTM-Config (or similar UE variable) associated with the SCG. In the above scenario, the UE 102 also releases the generated UE configuration (if any, generated using a previously received LTM reference configuration) related to the received LTM candidate cell configurations stored in the corresponding UE variable (for example, VarLTM-UE-Config) associated with the SCG, and generates a new UE configuration for all the applicable LTM candidate cells and stores in the corresponding UE variable (for example, VarLTM-UE-Config) associated with SCG.

In an embodiment herein, if the UE 102 receives the LTM configuration (for example. LTM candidate configuration) from the MN 112 and the configuration is associated with SCG in a RRC message such as RRC Reconfiguration and the LTM candidate configuration includes a configuration to modify LTM reference configuration, then the UE 102 modifies the received LTM reference configuration in the VarLTM-Config (or similar UE variable) associated with the SCG. In the above scenario, the UE 102 also releases the generated UE configuration (if any, generated using a previously received LTM reference configuration) related to the received LTM candidate cell configurations stored in the corresponding UE variable (for example, VarLTM-UE-Config) associated with the SCG, generates a new UE configuration for all the applicable LTM candidate cells, and stores in the corresponding UE variable (e.g. VarLTM-UE-Config) associated with SCG.

In an embodiment herein, if the UE 102 receives LTM configuration (for example, LTM candidate configuration) from the MN 112 and the configuration is associated with SCG, in a RRC message such as RRC reconfiguration message and the LTM candidate configuration includes a configuration to release LTM reference configuration, then the UE 102 releases the received LTM reference configuration in the VarLTM-Config (or similar UE variable) associated with the SCG. In the above scenario, the UE 102 also releases the generated UE configuration (if any, generated using a previously received LTM reference configuration) related to the received LTM candidate cell configurations stored in the corresponding UE variable (for example, VarLTM-UE-Config) associated with the SCG.

In an embodiment herein, if the UE 102 receives LTM configuration (for example, LTM candidate configuration) from the MN 112 and the configuration is associated with SCG in a RRC message such as RRC Reconfiguration and the LTM candidate configuration includes a configuration to release LTM candidate cell, (for example, including LTM candidate cell index, such as ltm-Candidateld), then the UE 102 releases the received LTM candidate cell in the VarLTM-Config (or similar UE variable) associated with the SCG.

In an embodiment herein, if the UE 102 receives the LTM configuration (for example, LTM candidate configuration) from the MN 112 in a RRC message such as RRC reconfiguration message and the configuration is associated with SCG, and the LTM candidate configuration includes a configuration to add (i.e. setup) LTM candidate cell, (for example, including LTM candidate cell index, such as ltm-Candidateld), then the UE 102 adds the received LTM candidate cell in the VarLTM-Config (or similar UE variable) associated with the SCG.

In an embodiment herein, if the UE 102 receives the LTM configuration (for example, LTM candidate configuration) from the MN 112 in a RRC message such as RRC Reconfiguration and the configuration is associated with SCG, and the LTM candidate configuration includes a configuration to release LTM candidate cell, (for example, including LTM candidate cell index, such as ltm-Candidateld), then the UE 102 releases the generated LTM candidate cell in the VarLTM-Config (or similar UE variable) associated with the SCG. In the above scenario, the UE 102 also releases the generated UE configuration related to the received LTM candidate cell configurations stored in the corresponding UE variable (for example, VarLTM-UE-Config) associated with the SCG.

In an embodiment herein, if the UE 102 receives LTM configuration (for example, LTM candidate configuration) from the MN 112 in a RRC message such as RRC Reconfiguration and the configuration is associated with SCG and the LTM candidate configuration includes a configuration to add (i.e. setup) LTM candidate cell, (for example, including LTM candidate cell index, such as ltm-Candidateld), then the UE 102 adds the received LTM candidate cell in the VarLTM-Config (or similar UE variable) associated with the SCG. In the above scenario, the UE 102 also generates UE configuration related to the received LTM candidate cell configurations and stores in the corresponding UE variable (for example, VarLTM-UE-Config) associated with the SCG.

In an embodiment herein, if the UE 102 receives the LTM configuration (for example, LTM candidate configuration) from the MN 112 in a RRC message such as RRC Reconfiguration and the configuration is associated with SCG and the LTM candidate configuration includes a configuration to release the sets of candidate cells in which full L2 reset is not performed upon LTM cell switch or to release one candidate cell from the set of candidate cells in which full L2 reset is not performed upon LTM cell switch, then the UE 102 releases the received sets of candidate cells in which full L2 reset is not performed upon LTM cell switch (or to release one candidate cell from the set of candidate cells in which full L2 reset is not performed upon LTM cell switch, in case it is received to be released) in the VarLTM-Config (or similar UE variable) associated with the SCG.

In an embodiment herein, if the UE 102 receives the LTM configuration (for example, LTM candidate configuration) from the MN 112 in a RRC message such as RRC reconfiguration message and the LTM candidate configuration includes a configuration to add the sets of candidate cells in which full L2 reset is not performed upon LTM cell switch or to release one candidate cell from the set of candidate cells in which full L2 reset is not performed upon LTM cell switch, then the UE 102 adds the received sets of candidate cells in which full L2 reset is not performed upon LTM cell switch (or to release one candidate cell from the set of candidate cells in which full L2 reset is not performed upon LTM cell switch, in case it is received to be released) in the VarLTM-Config (or similar UE variable) associated with the SCG.

In the above embodiments, if the LTM configuration for MCG and SCG are stored in the same UE variable (for example, one VarLTM-Config and/or one VarLTM-UE-Config) for both MCG and SCG, then the UE 102 identifies the configurations associated to SCG and performs the respective operation as in the above embodiments (adds/modifies/performs setup/release the LTM configuration).

The above embodiments, and relevant sections and actions are equally applicable for the occurrence of an event like autonomous removal of LTM candidate cells or the reception of RRC Resume instead of the reception of RRC reconfiguration.

FIG. 2 illustrates a block representation of the MN 112. The MN 112 comprises a processor 202, a communication module 204, and a memory module 206. The processor 202 can generate at least one MCG LTM configuration associated with the MCG. The processor 202 can receive at least one SCG LTM configuration associated with the SCG from the SN 114 in a SN RRC reconfiguration message. The processor 202 can embed the received SCG RRC reconfiguration message including the SCG LTM configuration in the MN RRC reconfiguration message. Further, the processor 202 can send at least one of the generated MCG LTM configuration associated with the MCG, and the embedded SCG RRC reconfiguration message including the SCG LTM configuration associated with the SCG, to the UE 102, in the MN RRC reconfiguration message via SRB1. The UE 102 can thereby perform at least one LTM operation for at least one of the MCG and the SCG independently using the MCG LTM configuration, and the SCG LTM configuration.

FIG. 3 illustrates a block representation of the SN 114. The SN 114 comprises a processor 302, a communication module 304, and a memory module 306. The processor 302 can generate at least one SCG LTM configuration associated with the SCG. The processor 302 can send the generated at least one SCG LTM configuration associated with the SCG to at least one of the UE 102, and the MN 112. The UE 102 can thereby perform at least one LTM operation for the SCG using the SCG LTM configuration. The processor 302 can send the generated SCG LTM configuration associated with the SCG, to the UE 102, in the SN RRC reconfiguration message via SRB3, for enabling the UE 102 to perform at least one LTM operation. In an embodiment herein, the processor 302 can send the generated SCG LTM configuration associated with the SCG in a SN RRC Reconfiguration message to the MN 112. The MN 112 can further embed the SN RRC reconfiguration message containing SCG LTM configuration in the MN RRC reconfiguration message and send the MN RRC reconfiguration message embedded with the SCG RRC reconfiguration message containing LTM configuration to the UE 102 via SRB1 to perform the LTM operation.

In an embodiment herein, the processor 106 of the UE 102, the processor 202 of the MN 112, and the processor 302 of the SN 114 can process and execute data of a plurality of modules of the UE 102, the MN 112, and the SN 114 respectively. The processor 106, the processor 202, and the processor 302 can be configured to execute instructions stored in the memory module 110 of the UE 102, the memory module 206 of the MN 112, and the memory module 306 of the SN 114 respectively. The processor 106, the processor 202, and the processor 302 may comprise one or more of microprocessors, circuits, and other hardware configured for processing. The processor 106, the processor 202, and the processor 302 can be at least one of a single processer, a plurality of processors, multiple homogeneous or heterogeneous cores, multiple Central Processing Units (CPUs) of different kinds, microcontrollers, special media, and other accelerators. The processor 106, the processor 202, and the processor 302 may be an application processor (AP), a graphics-only processing unit (such as a graphics processing unit (GPU), a visual processing unit (VPU)), and/or an Artificial Intelligence (AI)-dedicated processor (such as a neural processing unit (NPU)).

In an embodiment herein, the plurality of modules of the processor 106, the processor 202, and the processor 302 can communicate via the communication module 108 of the UE 102, the communication module 204 of the MN 112, and the communication module 304 of the SN 114 respectively. The communication module 108, the communication module 204, and the communication module 304 may be in the form of either a wired network or a wireless communication network module. The wireless communication network may comprise, but not limited to, Global Positioning System (GPS), Global System for Mobile Communications (GSM), Wi-Fi, Bluetooth low energy, Near-field communication (NFC), and so on. The wireless communication may further comprise one or more of Bluetooth, ZigBee, a short-range wireless communication (such as Ultra-Wideband (UWB)), and a medium-range wireless communication (such as Wi-Fi) or a long-range wireless communication (such as 3G/4G/5G/6G and non-3GPP technologies or WiMAX), according to the usage en-vironment.

In an embodiment herein, the memory module 110 of the UE 102, the memory module 206 of the MN 112, and the memory module 306 of the SN 114 may comprise one or more volatile and non-volatile memory components which are capable of storing data and instructions of the modules of the UE 102, of the MN 112, and the SN 114 to be executed. Examples of the memory module 110, the memory module 206, and the memory module 306 can be, but not limited to, NAND, embedded Multi Media Card (eMMC), Secure Digital (SD) cards, Universal Serial Bus (USB), Serial Advanced Technology Attachment (SATA), solid-state drive (SSD), and so on. The memory module 110, the memory module 206, and the memory module 306 may also include one or more computer-readable storage media. Examples of non-volatile storage elements may include magnetic hard discs, optical discs, floppy discs, flash memories, or forms of electrically programmable memories (EPROM) or electrically erasable and programmable (EEPROM) memories. In addition, the memory module 110, the memory module 206, and the memory module 306 may, in some examples, be considered a non-transitory storage medium. The term “non-transitory” may indicate that the storage medium is not embodied in a carrier wave or a propagated signal. However, the term “non-transitory” should not be interpreted to mean that the memory module 110, the memory module 206, and the memory module 306 is non-movable. In certain examples, a non-transitory storage medium may store data that can, over time, change (for example, in Random Access Memory (RAM) or cache).

FIG. 1 shows example modules of the UE 102, but it is to be understood that other embodiments are not limited thereon. In other embodiments, the UE 102 may include less or more number of modules. Further, the labels or names of the modules are used only for illustrative purpose and does not limit the scope of the invention. One or more modules can be combined together to perform same or substantially similar function in the UE 102.

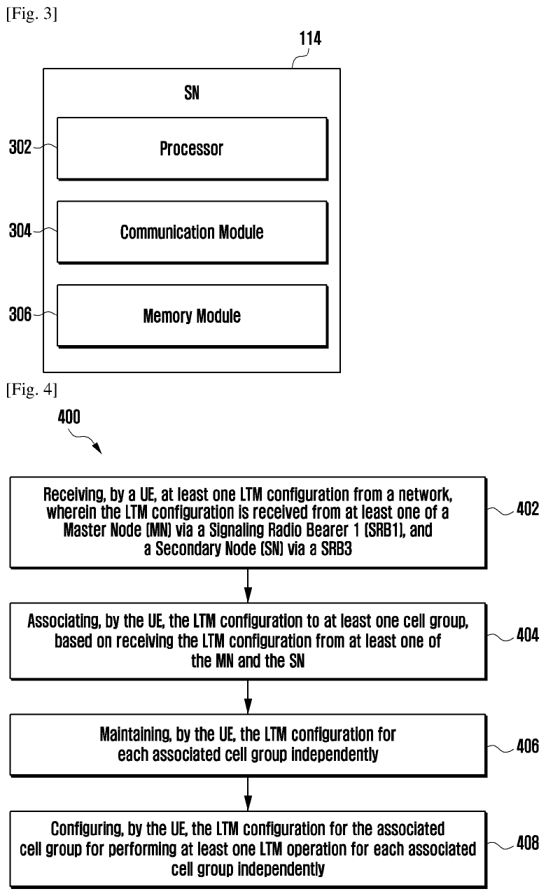

FIG. 4 illustrates a method 400 for managing LTM in NR-DC. The method 400 comprises receiving, by the UE 102, at least one LTM configuration from the network 104, as depicted in step 402. The LTM configuration is received from at least one of the MN 112 via SRB1, and the SN 114 via SRB3. The method 400 comprises associating, by the UE 102, the LTM configuration to at least one cell group, as depicted in step 404, based on receiving the LTM configuration from at least one of the MN 112 and the SN 114.

Thereafter, the method 400 comprises maintaining, by the UE 102, the LTM configuration, as depicted in step 406, for each associated cell group independently, as depicted in step 408. Further, the method 400 comprises configuring, by the UE 102, the LTM configuration for at least one associated cell group, as depicted in step 410, for performing at least one LTM operation for each associated cell group independently.

The various actions in method 400 may be performed in the order presented, in a different order or simultaneously. Further, in some embodiments, some actions listed in FIG. 4 may be omitted.

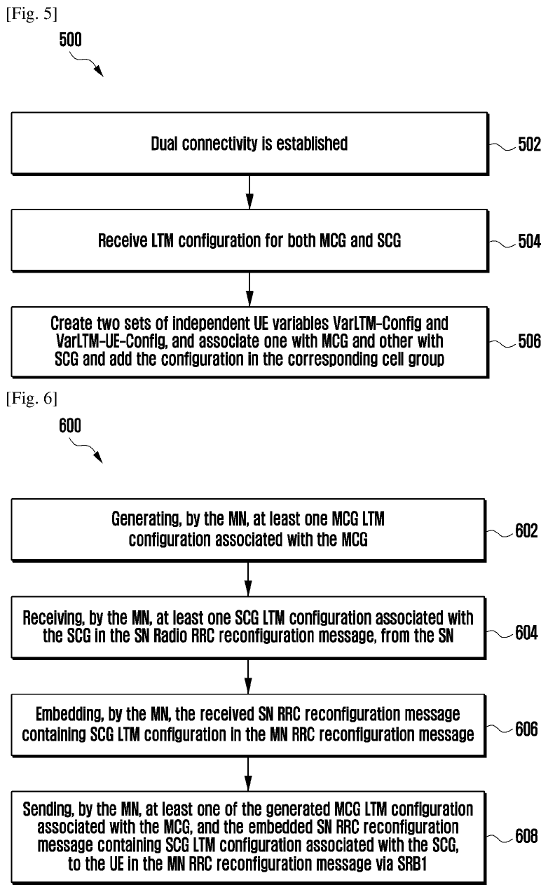

FIG. 5 is a flow chart illustrating a method 500 for creating different UE variables for SCG and MCG in LTM. The method 500 comprises. As depicted in step 502, the UE 102 establishes dual connectivity. Once, dual connectivity is established, the UE 102 receives LTM configuration for both MCG and SCG, as depicted in step 504. Later, the UE 102 creates two sets of independent UE variables VarLTM-Config and VarLTM-UE-Config, associates one UE variable with MCG and other UE variable with SCG, and adds the configuration in corresponding cell group (MCG, SCG), as depicted in step 506.

The various actions in method 500 may be performed in the order presented, in a different order or simultaneously. Further, in some embodiments, some actions listed in FIG. 5 may be omitted.

FIG. 6 is a method 600 for managing LTM by the MN 112. The method 600 comprises generating, by the MN 112, at least one MCG LTM configuration associated with the MCG, as depicted in step 602. The method 600 comprises receiving, by the MN 112, at least one SCG LTM configuration associated with the SCG, from the SN 114 in the SN RRC reconfiguration message, as depicted in step 604. The method 600 comprises embedding, by the MN 112, the received SN RRC reconfiguration message containing the SCG LTM configuration in the MN RRC reconfiguration message, as depicted in step 606.

Thereafter, the method 600 comprises sending, by the MN 112, at least one of the generated MCG LTM configuration associated with the MCG, and the embedded SN RRC reconfiguration message containing SCG LTM configuration associated with the SCG, to the UE 102 in the MN RRC reconfiguration message via SRB1, as depicted in step 608. Later, the UE 102 performs at least one LTM operation for at least one of the MCG and the SCG independently using at least one of the MCG LTM configuration, and the SCG LTM configuration.

The various actions in method 600 may be performed in the order presented, in a different order or simultaneously. Further, in some embodiments, some actions listed in FIG. 6 may be omitted.

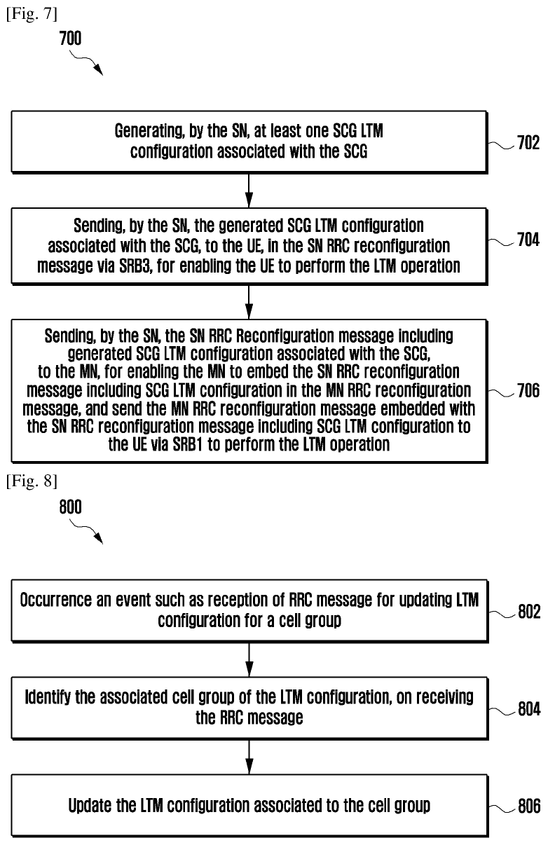

FIG. 7 is a method 700 for managing LTM by the SN 114. The method 700 comprises generating, by the SN 114, at least one SCG LTM configuration associated with the SCG, as depicted in step 702. Thereafter, the method 700 comprises sending, by the SN 114, the generated SCG LTM configuration associated with the SCG, to the UE 102, in the SN RRC reconfiguration message via SRB3, as depicted in step 704, for enabling the UE 102 to perform the LTM operation. Further, the method 700 comprises sending, by the SN 114, the generated SCG LTM configuration associated with the SCG, to the MN 112, as depicted in step 706, for enabling the MN 112 to embed the SN RRC reconfiguration message containing the SCG LTM configuration in the MN RRC reconfiguration message, and send the MN RRC reconfiguration message embedded with the SCG LTM configuration to the UE 102 via SRB1 to perform the LTM operation.

The various actions in method 700 may be performed in the order presented, in a different order or simultaneously. Further, in some embodiments, some actions listed in FIG. 7 may be omitted.

FIG. 8 is a flow chart illustrating a method 800 for updating a LTM configuration. The method 800 comprises identifying, by the UE 102, occurrence of an event such as reception of an RRC message for updating LTM configuration for a cell group, as depicted in step 802. Thereafter, the method 800 comprises identifying, by the UE 102, the associated cell group of the LTM configuration, as depicted in step 804, on receiving the RRC message. Later, the method 800 comprises updating the LTM configuration associated to the cell group, as depicted in step 806.

The various actions in method 800 may be performed in the order presented, in a different order or simultaneously. Further, in some embodiments, some actions listed in FIG. 8 may be omitted.

The embodiments disclosed herein can be implemented through at least one software program running on at least one hardware device and performing network management functions to control the network elements. The network elements shown in FIG. 1 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the scope of the embodiments as described herein.

1. A method performed by a user equipment (UE) in a communication system, the method comprising:
obtaining a radio resource control (RRC) message including at least one layer1/layer2 triggered mobility (LTM) configuration associated with at least one of a master cell group (MCG) or a secondary cell group (SCG);
in case that two independent LTM configuration including an LTM configuration associated with the MCG and an LTM configuration associated with the SCG is received independently, maintaining two independent UE variable, each of the two independent UE variable being associated with each of the two independent LTM configuration; and
performing an LTM configuration procedure for the two independent LTM configuration independently.

2. The method of claim 1, further comprising:
in case that the at least one LTM configuration includes an LTM candidate for a modification and an LTM candidate identifier,
modifying each of the two independent UE variable independently based on the LTM candidate for the modification.

3. The method of claim 1, further comprising:
in case that the at least one LTM configuration includes an entry associated with an LTM candidate for a release, removing the entry from each of the two independent UE variable independently.

4. The method of claim 1,
wherein the LTM configuration associated with the MCG is received via signaling radio bearer (SRB) 1,
wherein the LTM configuration associated with the SCG is received via SRB 3 or the LTM configuration associated with the SCG that is embedded in the RRC message is received via SRB 1, and
wherein the at least one LTM configuration further comprises at least one of an LTM reference configuration, or an LTM measurement configuration.

5. A method performed by a base station in a communication system, the method comprising:
obtaining a radio resource control (RRC) message including at least one layer1/layer2 triggered mobility (LTM) configuration associated with at least one of a master cell group (MCG) or a secondary cell group (SCG); and
transmitting, to a user equipment (UE), the obtained RRC message;
wherein in case that two independent LTM configuration including an LTM configuration associated with the MCG and an LTM configuration associated with the SCG is received independently, two independent UE variable is maintained, each of the two independent UE variable being associated with each of the two independent LTM configuration; and
wherein an LTM configuration procedure for the two independent LTM configuration is performed independently.

6. The method of claim 5,
wherein in case that the at least one LTM configuration includes an LTM candidate for a modification and an LTM candidate identifier, each of the two independent UE variable is modified independently based on the LTM candidate for the modification.

7. The method of claim 5,
wherein in case that the at least one LTM configuration includes an entry associated with an LTM candidate for a release, the entry is removed independently from each of the two independent UE variable.

8. The method of claim 5,
wherein the LTM configuration associated with the MCG is received via signaling radio bearer (SRB) 1,
wherein the LTM configuration associated with the SCG is received via SRB 3 or the LTM configuration associated with the SCG that is embedded in the RRC message is received via SRB 1, and
wherein the at least one LTM configuration further comprises at least one of an LTM reference configuration, or an LTM measurement configuration.

9. A user equipment (UE) in a communication system, the UE comprising:
a transceiver; and
a controller coupled with the transceiver configured to:
obtain a radio resource control (RRC) message including at least one layer1/layer2 triggered mobility (LTM) configuration associated with at least one of a master cell group (MCG) or a secondary cell group (SCG),
in case that two independent LTM configuration including an LTM configuration associated with the MCG and an LTM configuration associated with the SCG is received independently, maintain two independent UE variable, each of the two independent UE variable being associated with each of the two independent LTM configuration, and perform an LTM configuration procedure for the two independent LTM configuration independently.

10. The UE of claim 9, wherein the controller is further configured to:
in case that the at least one LTM configuration includes an LTM candidate for a modification and an LTM candidate identifier, modify each of the two independent UE variable independently based on the LTM candidate for the modification.

11. The UE of claim 9, wherein the controller is further configured to:
in case that the at least one LTM configuration includes an entry associated with an LTM candidate for a release, remove the entry independently from each of the two independent UE variable.

12. The UE of claim 9,
wherein the LTM configuration associated with the MCG is received via signaling radio bearer (SRB) 1,
wherein the LTM configuration associated with the SCG is received via SRB 3 or the LTM configuration associated with the SCG that is embedded in the RRC message is received via SRB 1, and
wherein the at least one LTM configuration further comprises at least one of an LTM reference configuration, or an LTM measurement configuration.

13. A base station in a communication system, the base station comprising:
a transceiver; and
a controller coupled with the transceiver configured to:
obtain a radio resource control (RRC) message including at least one layer1/layer2 triggered mobility (LTM) configuration associated with at least one of a master cell group (MCG) or a secondary cell group (SCG); and
transmit, to a user equipment (UE), the obtained RRC message;
wherein in case that two independent LTM configuration including an LTM configuration associated with the MCG and an LTM configuration associated with the SCG is received independently, two independent UE variable is maintained, each of the two independent UE variable being associated with each of the two independent LTM configuration; and
wherein an LTM configuration procedure for the two independent LTM configuration is performed independently.

14. The base station of claim 13,
wherein in case that the at least one LTM configuration includes an LTM candidate for a modification and an LTM candidate identifier, each of the two independent UE variable is modified independently based on the LTM candidate for the modification, and
wherein in case that the at least one LTM configuration includes an entry associated with an LTM candidate for a release, the entry is removed independently from each of the two independent UE variable.

15. The base station of claim 13,
wherein the LTM configuration associated with the MCG is received via signaling radio bearer (SRB) 1,
wherein the LTM configuration associated with the SCG is received via SRB 3 or the LTM configuration associated with the SCG that is embedded in the RRC message is received via SRB 1, and
wherein the at least one LTM configuration further comprises at least one of an LTM reference configuration, or an LTM measurement configuration.
